(19) United States
(12) Patent Application Publication
(10) Pub. No.: US 2010/0124171 A1
(43) Pub. Date: May 20, 2010

(54) WIRELESS STATION, FAULT DETECTING METHOD, AND COMPUTER READABLE MEDIUM

(75) Inventors: Seijiro Yoneyama, Yokohama-Shi (JP); Akira Ichie, Saitama-Shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/558,762

(22) Filed: Sep. 14, 2009

(30) Foreign Application Priority Data
Nov. 17, 2008 (JP) 2008-293489

(51) Int. Cl. H04L 12/26

(52) U.S. Cl. 370/242

(57) ABSTRACT

A wireless station includes a measuring unit measuring first and second communication delays of first and second wireless terminals; a first determining unit determining first and second transmission rates of the first and second wireless terminals; a second determining unit determining first and second timings of transmitting a response request frame and first and second lengths of response frames to be returned from the first and second wireless terminals; a transmitting unit transmitting a response request frame that requests returning of response frames of the first and second lengths at the first and second transmission rates, at the first and second transmission timings; a detecting unit detecting that the first and second wireless terminals are in hidden terminal relation upon detecting a collision of the response frames returned from the first and second wireless terminals.

### CROSS REFERENCE TO RELATED APPLICATIONS

This application is based upon and claims the benefit of priority from the prior Japanese Patent Applications No. 2008-293489, filed on Nov. 17, 2008; the entire contents of which are incorporated herein by reference.

### BACKGROUND OF THE INVENTION

1. Field of the Invention

The present invention relates to a wireless station, a fault detecting method, and a computer readable medium.

2. Related Art

A problem associated with a wireless system compliant with IEEE802.11 standard is that a radiowave interference fault occurs and degrades communication capability of wireless terminals. One of major causes of radiowave interference is the problem of hidden terminals.

A wireless terminal compliant with IEEE802.11 standard has the ability of Carrier Sense Multiple Access/Collision Avoidance (CSMA/CA) for refraining from transmission of wireless signals when it has detected a wireless signal transmitted from other wireless terminal so as to prevent interference of wireless signals with each other. The function of detecting a wireless signal is called carrier sensing. On the other hand, when wireless terminals are unable to detect each other by carrier sensing being separated by an obstruction such as a wall, one of the terminals cannot detect a wireless signal transmitted from the other terminal by carrier sensing and starts transmission of a wireless signal, which leads to interference of their wireless signals. This problem is generally called a hidden terminal problem. As errors occur in interfering frames and the frames are discarded, communication capability of wireless terminals degrades.

JP-A 06-232870 (Kokai) describes a method for detecting wireless terminals that are in hidden terminal relation. This method has wireless terminals attempt to directly transmit and receive test frames to/from each other and determines that they cannot detect each other by carrier sensing and are in hidden terminal relation if transmission and reception fail.

As mentioned above, the conventional method determines whether there is a hidden terminal relation or not based on direct transmission and reception of test frames between wireless terminals.

However, in infrastructure mode of IEEE802.11 standard, a wireless terminal is permitted to communicate only with a wireless base station with which it has a connection relation and the conventional method that involves direct transmission and reception of test frames between wireless terminals cannot be applied. Assuming that one of wireless terminals attempts transmission and reception of test frames according to the conventional method, the method always determines that the wireless terminals are in hidden terminal relation because the other wireless terminal does not receive the test frames and ignores them.

Also, carrier sensing according to IEEE802.11 standard bases its determination only on presence of electromagnetic wave and does not involve demodulation of data that has been modulated into wireless signals. In general, depending on reception signal strength of data, there can be a condition in which presence of electromagnetic wave is detected and carrier sensing succeeds but demodulation of data fails. If demodulation of test frames fails when transmission and reception of test frames are attempted in such a condition according to the conventional method, an incorrect result of determination is returned that indicates wireless terminals are in hidden terminal relation even if they are in a normal relation in which carrier sensing succeeds.

As described, the conventional method has a problem in accuracy of determination of a hidden terminal relation.

### SUMMARY OF THE INVENTION

According to an aspect of the present invention, there is provide a wireless station that performs wireless communication with first and second wireless terminals based on a carrier sensing scheme, comprising: a measuring unit configured to communicate with the first and second wireless terminals to measure first and second communication delays of the first and second wireless terminals; a first determining unit configured to determine first and second transmission rates of the first and second wireless terminals; a second determining unit configured to determine first and second timings of transmission for a response request frame to each of the first and second wireless terminals and first and second response frame lengths of response frames to be returned from the first and second wireless terminals, based on the first and second transmission rates, the first and second communication delays, and a range of an initial backoff time for carrier sensing; a transmitting unit configured to transmit a response request frame that requests returning of response frames having the first and second response frame length at the first and second transmission rates, to the first and second wireless terminals at the first and second transmission timings; a receiving unit configured to receive the response frames returned from the first and second wireless terminals; and a detecting unit configured to detect that the first and second wireless terminals are in hidden terminal relation upon detecting a collision of the response frames, wherein the second determining unit determines the first and second response frame lengths and the first and second transmission timings so that the response frames returned from the first and second wireless terminals collide with each other given that the first and second wireless terminals are in the hidden terminal relation.

### BRIEF DESCRIPTION OF THE DRAWINGS

FIG. 1 shows an illustrative configuration of a communication system according to an embodiment of the present invention;

FIG. 2 is a block diagram showing an illustrative configuration of base station A in the communication system;

FIG. 3 shows a flow of processing for the base station A to transmit and receive ICMP Echo frames for measuring communication delay of wireless terminals H1 and H2;

FIG. 4 illustrates how the frame length of a response frame is determined;

FIG. 5 illustrates that frame collision does not occur between wireless terminals that are not in a hidden terminal relation because carrier sensing effectively functions;

FIG. 6 shows a flow of processing for the base station A to transmit and receive ICMP Echo frames to and from wireless terminals H1 and H2;

FIG. 7 is a flowchart illustrating a flow of operations of the base station;

FIG. 8 shows a flow of processing for the base station A to transmit and receive ICMP Echo frames to and from wireless terminals H2 and H3;

FIG. 9 shows the data frame format of IEEE802.11 standard;

FIG. 10 illustrates how to determine the frame length of a response frame when a response request frame is transmitted by multicast; and

FIG. 11 shows a flow of processing for the base station A to transmit and receive ICMP Echo frames to and from wireless terminals H1 and H2 by multicast.

### DETAILED DESCRIPTION OF THE INVENTION

Hereinafter, embodiments of the present invention will be described with reference to drawings.

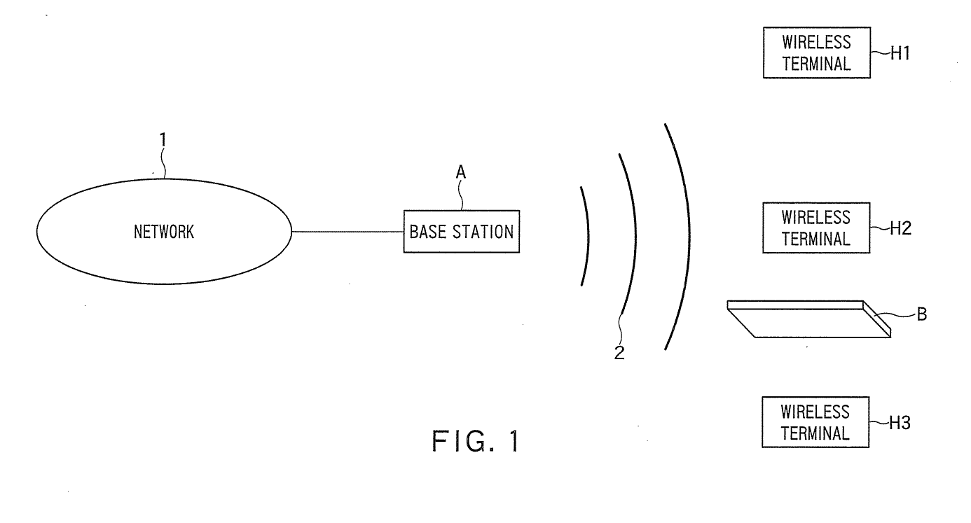

FIG. 1 shows an exemplary configuration of a communication system according to an embodiment of the present invention.

In FIG. 1, reference numeral 1 denotes a network and “A” is a base station (or an access point or AP) connected to the network 1. The base station A corresponds to a wireless station of the present invention, for example. Reference numeral 2 denotes a wireless link, and H1, H2 and H3 are wireless terminals (STAtions or STAs) connected to the wireless link 2. “B” is a wall that obstructs radiowave transmitted by the wireless terminals H2 and H3 so that radiowave does not reach the other terminal. It means that the wireless terminals H2 and H3 are in a hidden terminal situation with respect to each other, being in a relation that gives rise to a hidden terminal fault which causes frames transmitted by them to collide with each other. The base station A and wireless terminals H1, H2, and H3 perform communication according to a carrier sensing scheme. Although only three wireless terminals are connected to the base station A in FIG. 1, four or more wireless terminals may connect to the base station A.

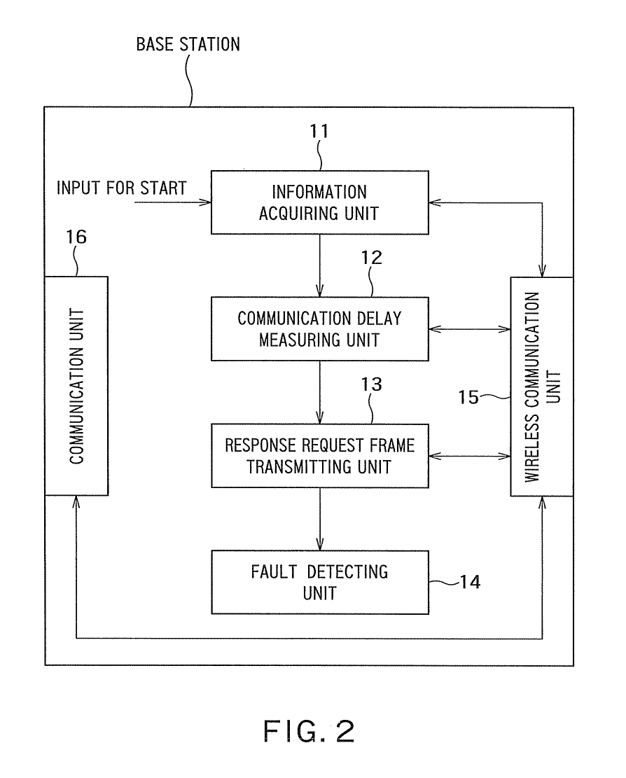

FIG. 2 shows a configuration of the base station A according to the present embodiment.

As shown in FIG. 2, base station A includes an information acquiring unit (acquiring unit) 11 for obtaining information on physical interface specifications of wireless terminals H1, H2 and H3 (transmission rates here); a communication delay measuring unit (measuring unit) 12 for measuring communication delay of the wireless terminals H1, H2 and H3; a response request frame transmitting unit (first determining unit, second determining unit, transmitting unit, third determining unit) 13 for generating a response request frame based on the transmission rates, communication delay, and the range of initial backoff time of test objects (two selected from wireless terminals H1 to H3) and transmitting the response request frame to the test objects; a fault detecting unit (detecting unit) 14 for determining whether there is a hidden terminal fault or not based on presence/absence of collision of response frames which are returned from the test objects in response to the response request frame; a wireless communication unit (receiving unit, transmitting unit) 15 for communicating with wireless terminals H1, H2 and H3; and a wired or wireless communication unit 16 which communicates with the network 1. The information acquiring unit 11, communication delay measuring unit 12, and response request frame transmitting unit 13 perform their respective processing via the wireless communication unit 15.

While the components 11, 12, 13, 14, 15 and 16 are described as being configured as hardware, it is not limitation and they may provide functions as software (program) executed in the base station A. Incidentally, the term “unit” may be replaced with “device” or “section” and so on.

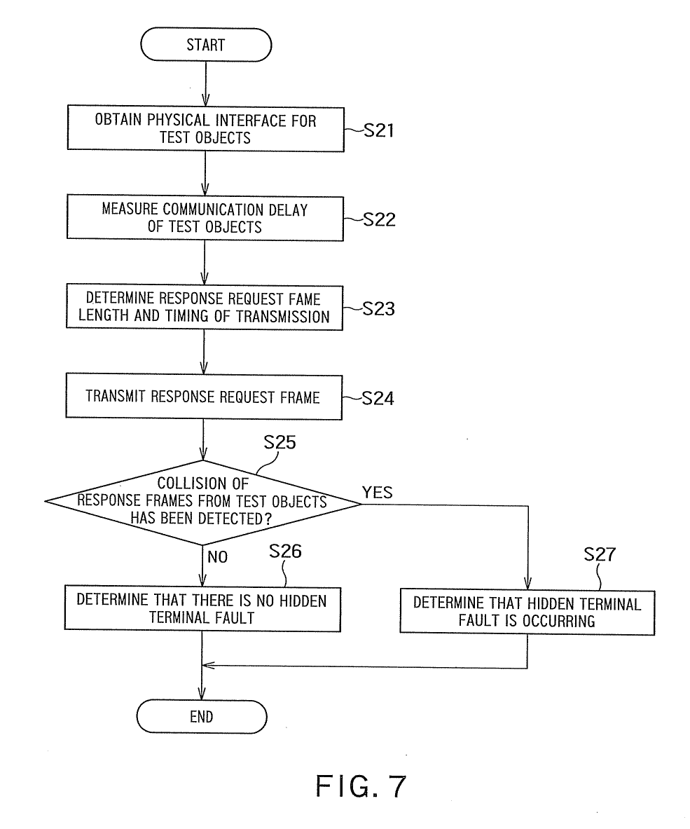

Hereinafter, firstly, description will be given about a flow of processing for determining at the base station A whether wireless terminals H1 and H2 as test targets are in a relation that causes a hidden terminal fault (i.e., a hidden terminal relation) (a first embodiment). The flow of processing by the base station A is shown in the flowchart of FIG. 7. This processing is performed in response to input from a user of an instruction for starting a test with wireless terminals H1 and H2 specified (see FIG. 1), for example.

The information acquiring unit 11 of the base station A obtains the transmission rates of the wireless terminals H1 and H2 as physical interface specifications used by the terminals for wireless communication (S21). The transmission rates may be obtained by the base station A defining a frame for making an inquiry to the wireless terminals H1 and H2, or by the base station A storing transmission rates that were used for frames received from the wireless terminals H1 and H2 and making reference to such transmission rates.

Next, the communication delay measuring unit 12 measures communication delay between the base station A and each of the wireless terminals H1 and H2 (S22). Communication delay may be measured by transmitting an ICMP Echo Request from base station A to each of the wireless terminals H1, H2 and measuring Round Trip Time (RU) until reception of an ICMP Echo Reply returned from them, for example.

Here, measurement may be performed separately for each terminal and a terminal as the target of measurement may be instructed to disable its backoff function. This allows communication delay to be measured without including backoff time. Also, to improve accuracy of measurement, measurement may be performed a number of times and an average value may be calculated.

In addition, when transmission error occurred in an ICMP Echo Reply and retransmission took place in MAC layer, the result of measurement for the retransmission may be excluded from measurement because it can cause disturbance.

Here, communication delay is measured for the following reason. In general, wireless terminals have differing performance in network processing and it causes a difference in input/output processing time from reception of an ICMP Echo Request to transmission of an ICMP Echo Replay onto a wireless link. If the frame length of a response frame and timing of transmitting a response request frame are determined by the response request frame transmitting unit 13, which is discussed later, without considering such a difference in processing time when the difference is large, it leads to degradation of the accuracy of the fault detecting unit 14. It is therefore important to actually measure communication delay by using ICMP Echo.

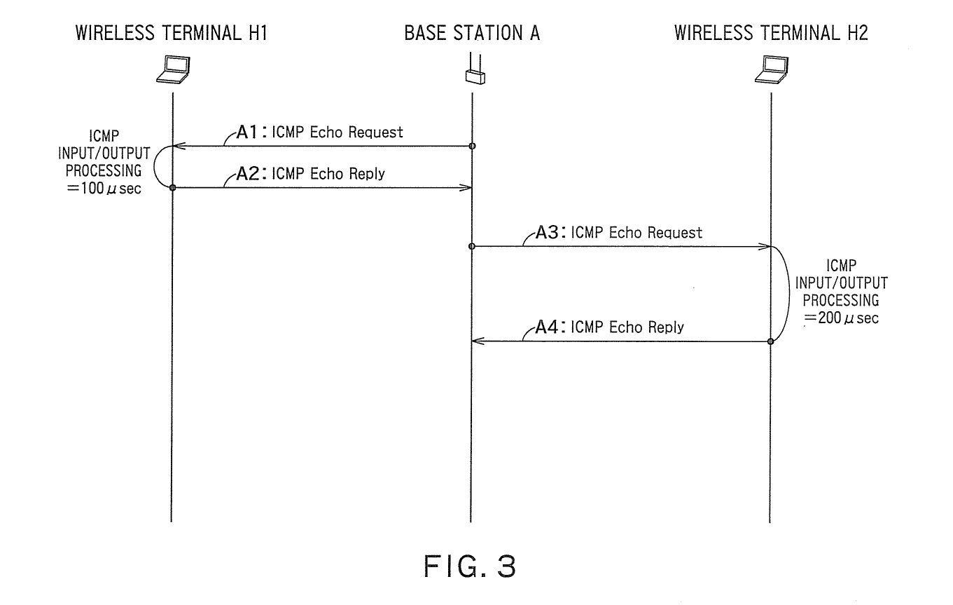

FIG. 3 shows a flow of processing for transmitting and receiving ICMP Echo frames for the base station A to measure communication delay of the wireless terminals H1 and H2.

The base station A transmits an ICMP Echo Request frame to wireless terminal H1 (A1), and receives an ICMP Echo Reply frame from wireless terminal H1 (A2). It is assumed here that a measured communication delay of wireless terminal H1 is 100 μsec. The base station A similarly transmits an ICMP Echo Request frame to wireless terminal H2 (A3), and receives an ICMP Echo Reply frame from wireless terminal H2 (A4). It is assumed here that a measured communication delay of wireless terminal H2 is 200 μsec. In this way, the base station A transmits and receives ICMP Echo frames by unicast when measuring communication delay. This is because if wireless terminals as targets of measurement are in hidden terminal relation, interference occurs in response frames and correct measurement cannot be performed.

Next, the response request frame transmitting unit 13 determines a response frame length and timing of transmitting a response request frame that ensure collision of response frames for each of the wireless terminals H1 and H2 based on their transmission rates and communication delay as well as the range of the initial backoff time (S23). The response frame length and timing of transmission are determined such that response frames collide with each other assuming that the wireless terminals H1 and H2 are in hidden terminal relation. The response request frame transmitting unit 13 transmits a response request frame that asks for returning of a response frame of the determined frame length at the transmission rates to the wireless terminals H1 and H2 at the timings of transmission for them (S23). Hereinafter, step S23 will be described in greater detail.

Assume first that the frame length of the response frame can be explicitly specified by base station A, which transmits a response request. For example, ICMP Echo Request and ICMP Echo Reply can be used for a response request frame and a response frame, respectively. This is because the base station A can also indirectly control the payload length of an ICMP Echo Reply by controlling the payload length of an ICMP Echo Request because there is an established rule that an ICMP Echo Reply should be returned with a payload length equal to that of an ICMP Echo Request. It is assumed that ICMP Echos are transmitted and received by unicast.

Here, assume that the base station A and wireless terminals H1, H2 use IEEE802.11a standard and they all have a transmission rate of 54 Mbps. Also, assume that communication delay of wireless terminals H1 and H2 is 100 μsec and 200 μsec, respectively (communication delay is measured with their backoff function disabled here). The base station A determines timing of transmission to the wireless terminals H1 and H2 such that a response request frame is first transmitted to the wireless terminal H2 and a response request frame is then transmitted to wireless terminal H1 after elapse of 100 μsec so that the wireless terminals H1 and H2 simultaneously transmit a response frame on the assumption that they have the same backoff time.

In IEEE802.11a standard, the initial backoff time for a wireless terminal to perform carrier sensing before transmitting data is randomly determined within a range of 0 to 135 μsec and this time newly emerges as a communication delay. Therefore, to ensure that response frames from the wireless terminals H1 and H2 collide with each other, it is necessary to determine such a frame length that makes the response frames occupy a wireless link for at least 135 μsec (the minimum value) or longer.

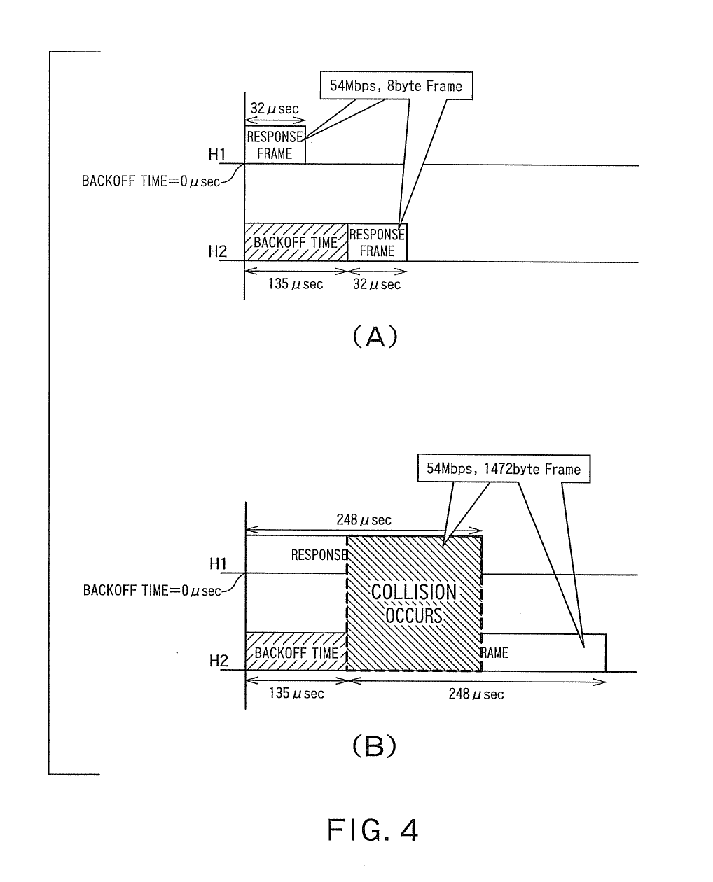

For example, as shown in FIG. 4(A), even if response request frames are transmitted to the wireless terminals H1 and H2 at their respective timings given that the transmission rate is 54 Mbps and the response frame length is 8 bytes (occupation time is 32 μsec), response frames from the wireless terminals H1 and H2 do not collide with each other when the backoff time of wireless terminal H1 is 0 μsec and that of wireless terminal H2 is 135 μsec.

On the other hand, as shown in FIG. 4(B), when the response frame length is set to a sufficiently large value, e.g., 1472 bytes, the time for which response frames occupy the wireless link is 248 μsec and frames can be caused to collide. While FIG. 4(B) shows an example of setting the response request frame length to a sufficiently large value of 1472 bytes, the response request frame length can be of course set to a smaller value as long as response frames occupy the wireless link exceeding the initial backoff time. Because efficiency of frequency utilization generally lowers with increase in traffic for system control and management, such as test packets, it is important to reduce such traffic as much as possible. While the response frame lengths for wireless terminals H1 and H2 are set to the same value in this example, they do not have to be the same value and may be any values that ensure collision of response frames.

Here, if communication delay is measured without disabling backoff function (i.e., being effective), the frame length may be determined such that response frames occupy the wireless link for at least a time period twice the length of the initial backoff time, for example.

Also, while in the description above the frame length and timing of transmission are determined using transmission rates obtained from the wireless terminals H1 and H2, transmission rates may also be specified by a base station separately for the wireless terminals. In such a case, a transmission rate which should be used by a wireless terminal for a response is specified in a response request frame, and the wireless terminal returns a response frame at the specified transmission rate. Incidentally, when transmission rates obtained from wireless terminals H1 and H2 are used, a transmission rate need not be explicitly specified when a response request frame is transmitted.

In addition, while in the description above a response request frame is first transmitted to wireless terminal H2 which has a communication delay of 200 μsec and thereafter a response request frame is transmitted to wireless terminal H1 which has a communication delay of 100 μsec upon elapse of 100 μsec, the present invention is not limited thereto and timing of transmission to wireless terminals H1 and H2 may be determined by an arbitrary method. In such a case, the difference in transmission timing and the difference in communication delay should be reflected in determination of frame length of a response frame. For example, when the wireless terminals have the same communication delay time, the difference in transmission timing should be reflected in the frame length of response frames. In short, such a frame length and timing of transmission should be determined that cause response frames from wireless terminals H1 and H2 to collide with each other given that they are in hidden terminal relation.

Next, the fault detecting unit 14 determines whether response frames have been received from wireless terminals H1 and H2 (whether there has been a collision of response frames) (S25). Here, carrier sensing of wireless terminals H1 and H2 effectively functions because the terminals are not in a hidden terminal situation. Therefore, each of the wireless terminals H1 and H2 avoids transmission of a response frame while the other one transmits a response frame and accordingly collision of frames does not occur. That is, the fault detecting unit 14 does not detect a collision of response frames from the wireless terminals H1 and H2. The fault detecting unit 14 therefore determines that the wireless terminals H1 and H2 are not in hidden terminal relation (i.e., that a hidden terminal fault is not occurring) (S26).

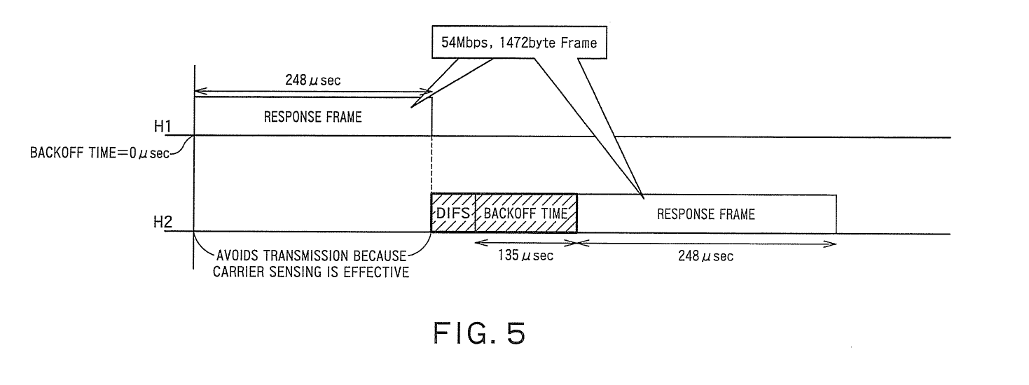

For instance, when the backoff time of wireless terminal H1 is 0 μsec and that of wireless terminal H2 is 135 μsec as shown in FIG. 5, wireless terminal H1 first starts transmission of a response frame, but wireless terminal H2 detects it by carrier sensing and thus avoids transmission of a response frame during transmission by the wireless terminal H1. After detecting absence of radiowave transmitted from the wireless terminal H1, the wireless terminal H2 makes sure that no radiowave is being detected by carrier sensing during DIFS and backoff time (135 μsec), and then transmits a response frame. Consequently, response frames from the wireless terminals H1 and H2 are normally received, and the fault detecting unit 14 determines that wireless terminals H1 and H2 are not in hidden terminal relation (that no hidden terminal fault is occurring) (S26).

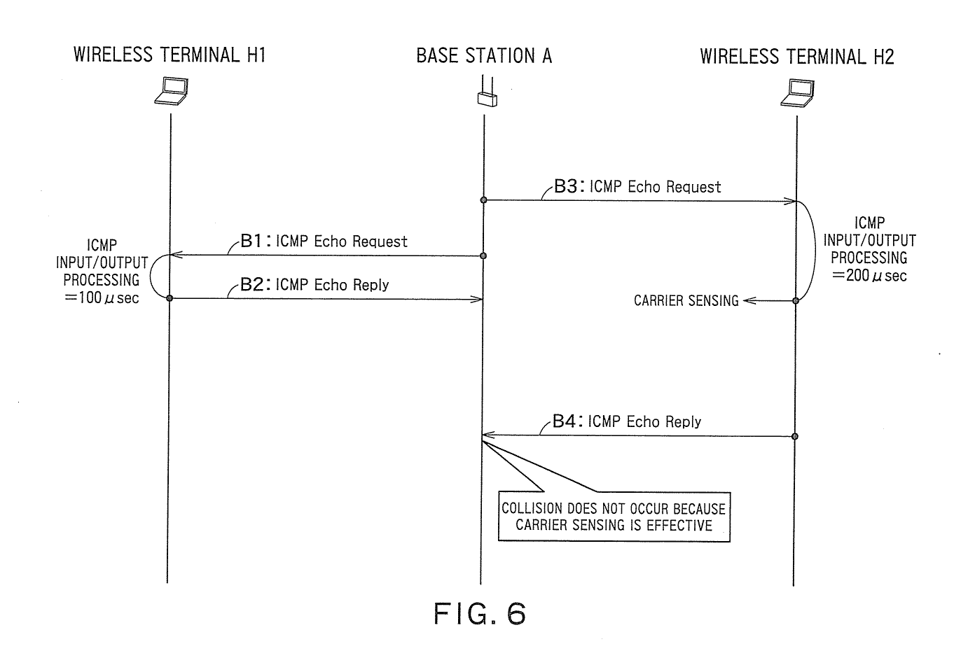

FIG. 6 shows a flow of processing for the base station A to transmit and receive ICMP Echo frames to and from wireless terminals H1 and H2 in the above-described example. It is understood that no occurrence of a hidden terminal fault is correctly detected when wireless terminals H1 and H2 that are not in a hidden terminal situation are test objects.

Hereinafter, description will be given about a flow of processing for determining at the base station A whether wireless terminals H2 and H3 as test objects are in a relation that causes a hidden terminal fault (a second embodiment). The flow of processing by base station A is shown in the flowchart of FIG. 7. This processing is performed in response to input of an instruction to start a test from the user specifying wireless terminals H2 and H3 (see FIG. 1), for example.

First, the information acquiring unit 11 of the base station A obtains transmission rates of wireless terminals H2 and H3 as physical interface specifications used by the terminals for wireless communication (S21).

Next, the communication delay measuring unit 12 measures communication delay between the base station A and each of the wireless terminals H2 and H3 (S22). The flow of transmission and reception of ICMP Echo frames relating to measurement of communication delay is similar to the one shown in FIG. 3 described in the first embodiment.

Next, a response frame length and timing of transmitting a response request frame that ensure collision of response frames are determined for each of the wireless terminals H2 and H3 based on their transmission rates and communication delay as well as the range of the initial backoff time (S23). Then, the response request frame transmitting unit 13 transmits a response request frame that asks for returning of a response frame of the determined response frame length to the wireless terminals H2 and H3 at the determined timings of transmission to them (S23).

It is assumed here that the base station A, and wireless terminals H2 and H3 use IEEE802.11a standard and have a transmission rate of 54 Mbps. It is also assumed that communication delay of wireless terminals H2 and H3 is 100 and 200 μsec, respectively. The base station A determines timing of transmission such that a response request frame is first transmitted to wireless terminal H3 and a response request frame is subsequently transmitted to wireless terminal H2 after elapse of 100 μsec so that the terminals simultaneously transmit a response frame assuming that they have the same backoff time, for example.

As mentioned earlier, in IEEE802.11a standard, the initial backoff time for a wireless terminal to perform carrier sensing before transmitting data is randomly determined within a range of 0 to 135 μsec, which newly emerges as a communication delay. Therefore, to ensure that response frames from the wireless terminals H2 and H3 collide with each other, it is necessary to determine such a frame length that makes response frames occupy a wireless link for at least a time period of 135 μsec (the minimum value) or longer. As the wireless terminals H2 and H3 both have a transmission rate of 54 Mbps, if response frame length is set to 1472 bytes, for example, response frames occupy a wireless link for a time period of 248 μsec and the frames can be caused to collide with each other (see FIG. 4(B)).

Next, the fault detecting unit 14 determines whether response frames have been received from wireless terminals H2 and H3 (whether there has been a collision of response frames) (S25). As the wireless terminals H2 and H3 are in a hidden terminal situation and carrier sensing does not function, the wireless terminal H3 does not avoid transmission of a response frame and frame collision occurs (see FIG. 4(B)). The fault detecting unit 14 therefore detects a collision of response frames from wireless terminals H2 and H3 and determines that a hidden terminal fault is occurring between the wireless terminals H2 and H3 (S27).

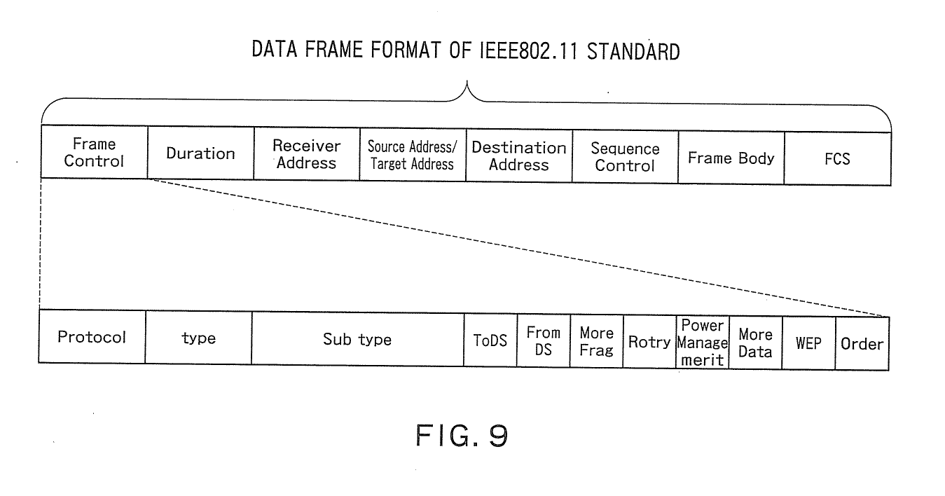

Collision of frames can be detected by a method that determines that there has been a collision if frame reception is not detected within a certain time period after transmission of a response request frame, for example. According to IEEE802.11 standard, retransmission of a frame takes place when frame error occurred due to interference or the like. As Retry field in a header portion of a retransmitted frame is set to “1”, whether a received frame is a retransmitted frame or not can be determined by referencing the value in Retry field of the frame, and it may be determined that a collision has occurred if it is a retransmitted frame. The data frame format of IEEE802.11 standard is shown in FIG. 9.

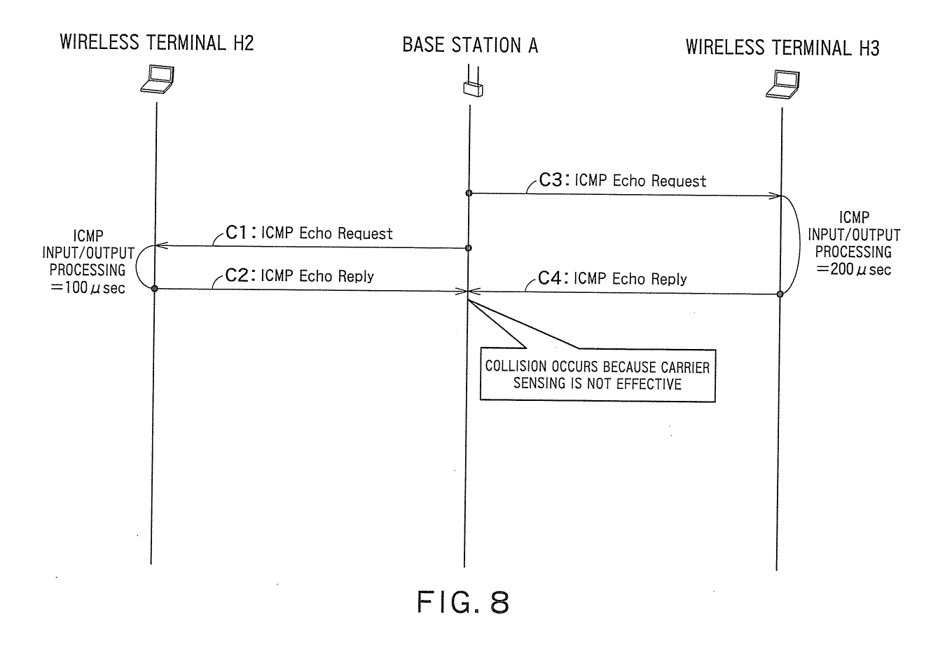

FIG. 8 shows a flow of processing for the base station A to transmit and receive ICMP Echo frames to and from wireless terminals H2 and H3 in the second embodiment described above. Note that indication of initial backoff time is omitted here. It is understood that no occurrence of a hidden terminal fault is correctly detected when wireless terminals H2 and H3 which are in a hidden terminal situation are test objects.

Hereinafter, processing for transmitting ICMP Echo Request, which is sent by the fault detecting unit 14, by multicast instead of unicast (a third embodiment) will be described.

Multicast refers to a communication mode in which data is transmitted to a particular group consisting of multiple wireless terminals, as opposed to unicast that transmits data to a single wireless terminal. For example, when the base station A transmits a frame having a particular multicast address, only a particular group assigned the particular multicast address (e.g. a pair of wireless terminals H1 and H2 or a pair of H2 and H3) performs reception of the frame.

Hereinafter, processing performed by the base station A will be described that checks whether wireless terminals H2 and H3 as test objects are in a relation that causes a hidden terminal fault. A flow of processing performed by base station A is shown in the flowchart of FIG. 7.

The information acquiring unit 11 of the base station A obtains the transmission rates of wireless terminals H2 and H3 as physical interface specifications used by the terminals for wireless communication (S21).

Next, the communication delay measuring unit 12 measures communication delay between the base station A and each of wireless terminals H2 and H3 (S22). It is assumed that communication delay is measured by transmitting and receiving ICMP Echo by unicast. The flow of transmitting and receiving ICMP Echo frames relating to measurement of communication delay is similar to the one shown in FIG. 3 which was described in the first embodiment.

Then, the response request frame transmitting unit 13 determines a frame length common to wireless terminals H2 and H3 that ensures their response frames collide with each other based on the transmission rates and communication delay of wireless terminals H2 and H3, and the range of initial backoff time (S23). Such a frame length corresponds to a common response frame length of the present invention, for example. The response request frame is transmitted to the wireless terminals H2 and H3 at the same time because it is transmitted by multicast.

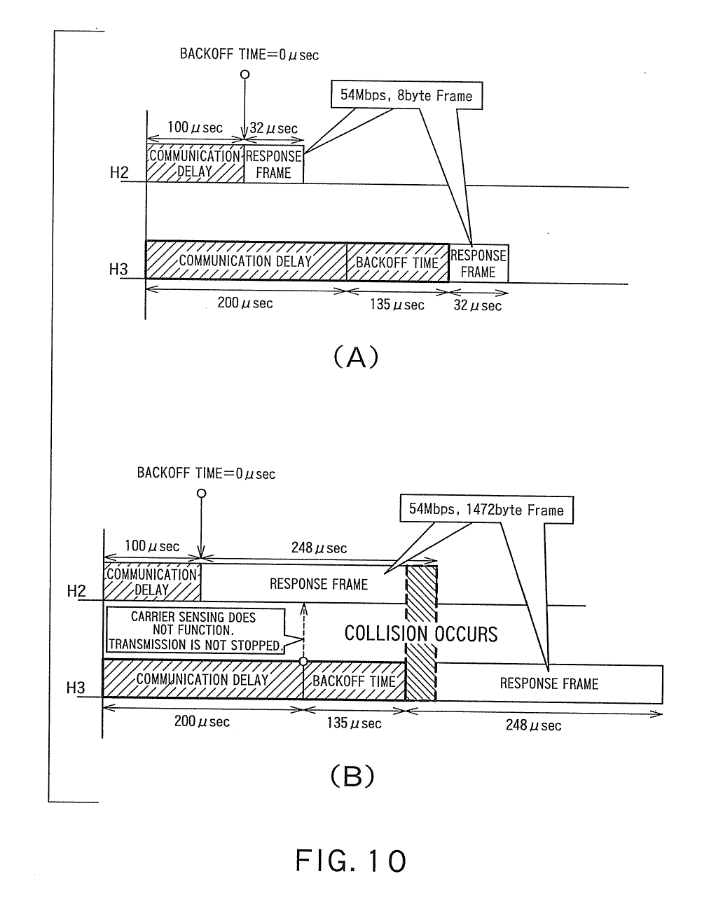

Here, assume that base station A and wireless terminals H2 and H3 use IEEE802.11a standard and have a transmission rate of 54 Mbps. It is also assumed that communication delay of wireless terminals H2 and H3 is 100 μsec and 200 μsec, respectively (communication delay is measured with their backoff function disabled). In addition, as mentioned earlier, IEEE802.11a standard randomly determines the initial backoff time in which a wireless terminal performs carrier sensing before transmitting data within a range of 0 to 135 μsec, which newly emerges as a communication delay. In this situation, the minimum value of time required before the wireless terminal H2 transmits a response frame to wireless link 2 is 100 μsec+0 μsec=100 μsec, and the maximum value of time required before wireless terminal H3 transmits a response frame to wireless link 2 is 200 μsec+135 μsec=335 μsec. Therefore, to ensure collision of response frames from wireless terminals H2 and H3, it is required to determine such a frame length that makes the response frames occupy the wireless link for at least 335 μsec−100 μsec=235 μsec. Since transmission rate is set to 54 Mbps here, if response frame length is set to 1472 bytes, for example, the response frames occupy the wireless link for 248 μsec and the frames can be caused to collide. This is illustrated in FIG. 10(B). On the other hand, if response frame length is set to 8 bytes, for example, time of occupation becomes sufficiently shorter than 235 μsec and frame collision cannot be caused, as shown in FIG. 10(A). While the above description assumes a case where communication delay is measured with the backoff function of the wireless terminals disabled, if backoff function is enabled at the time of measurement, the time for which response frames occupy the wireless link can be at least: 235 μsec+the length of the initial backoff time, i.e., 135 μsec=370 μsec, for example.

When the difference in communication delay of wireless terminals H2 and H3 is large, a wireless link occupation time sufficient for causing collision of frames might not be secured just by making the response request frame length large since the upper limit on frame length is limited. In such a case, the time for which response frames occupy the wireless link can be further increased to cause a collision by decreasing the transmission rates of wireless terminals H2 and H3. The transmission rates can be decreased by explicitly specifying transmission rates by the base station A by indicating transmission rates that should be used by wireless terminals H2 and H3 in the payload of response request frames sent from the base station A to wireless terminals H2 and H3, for example.

Next, the response request frame transmitting unit 13 sets response request frame length to 1472 bytes, and sends a response request frame with a multicast address to which the wireless terminals H2 and H3 belong (S24). In other words, the response request frame is transmitted to the wireless terminals H2 and H3 at the same time. Although a multicast address is illustrated here, an ICMP Echo Request may be instead transmitted by broadcast when two wireless terminals are connected to the base station A.

Next, the fault detecting unit 14 determines whether there has been a collision of response frames from wireless terminals H2 and H3 (S25). Because wireless terminals H2 and H3 are in a hidden terminal situation and cannot detect radiowave from each other by carrier sensing, wireless terminal H3 does not avoid transmission of a response frame and collision of frames occurs (FIG. 10(B)). Therefore, a collision of response frames from wireless terminals H2 and H3 is detected, and the fault detecting unit 14 determines that a hidden terminal fault is occurring between wireless terminals H2 and H3 (S27).

As mentioned above, collision of frames can be detected by a method that determines that there has been a collision if frame reception is not detected within a certain time period, for example. Also, according to IEEE802.11 standard, retransmission of a frame takes place when frame error occurred due to interference or the like. As Retry field in a header portion of a retransmitted frame is set to “1”, whether a received frame is a retransmitted frame or not can be determined by referencing the value in Retry field of the frame, and it may be determined that collision has occurred if it is a retransmitted frame.

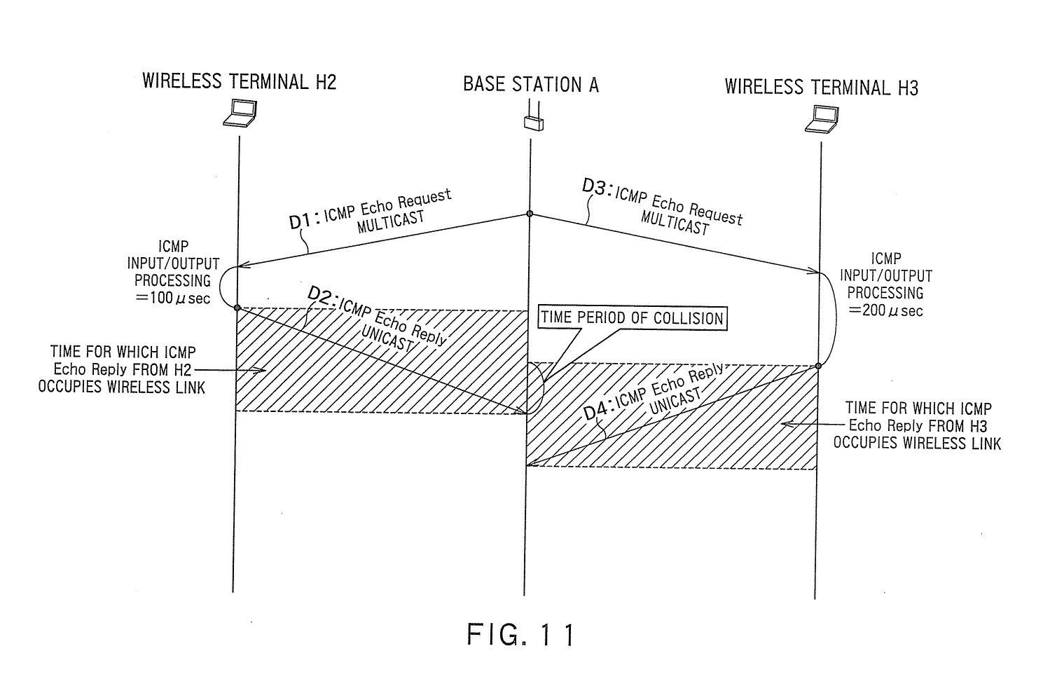

A flow of processing for base station A to transmit and receive ICMP Echo frames to and from wireless terminals H2 and H3 in the third embodiment described above is shown in FIG. 11. Note that indication of initial backoff time is omitted. As can be seen from FIG. 11, occurrence of a hidden terminal fault between test objects can be detected using a multicast response request frame when wireless terminals H2 and H3 which are in a hidden terminal situation are test objects.

As has been described, according to the embodiments of the present invention, it is possible to detect wireless terminals that are in hidden terminal relation with high accuracy in a wireless LAN system. That is, unlike the method adopted by the conventional technique of JP-A 06-232870 (Kokai) that determines presence/absence of a hidden terminal relation by wireless terminals attempting direct transmission and reception of a response request frame therebetween, the embodiments of the present invention determine whether there is hidden terminal relation or not by transmitting a response request frame from a base station to wireless terminals to see whether interference actually occurs. The conventional method has the problem of decreased accuracy of determination, whereas the present method directly judges the essence of whether a pair of wireless terminals actually causes interference or not and has an advantage of the ability to reliably detect presence or absence of a hidden terminal relation. In addition, the present method may be reused without requiring modification to existing hardware or software and can be implemented and realized at a low cost because it does not violate infrastructure mode specifications of the IEEE802.11 standard that does not permit direct communication between wireless terminals.

What is claimed is:

1. A wireless station that performs wireless communication with first and second wireless terminals based on a carrier sensing scheme, comprising:
a measuring unit configured to communicate with the first and second wireless terminals and measure first and second communication delays of the first and second wireless terminals;
a first determining unit configured to determine first and second transmission rates of the first and second wireless terminals;
a second determining unit configured to determine first and second timings of transmitting a response request frame to each of the first and second wireless terminals and first and second response frame lengths of response frames to be returned from the first and second wireless terminals, based on the first and second transmission rates, the first and second communication delays, and a range of an initial backoff time for carrier sensing;
a transmitting unit configured to transmit a response request frame that requests returning of response frames having the first and second response frame lengths at the first and second transmission rates, to the first and second wireless terminals at the first and second transmission timings;
a receiving unit configured to receive the response frames returned from the first and second wireless terminals; and
a detecting unit configured to detect that the first and second wireless terminals are in hidden terminal relation upon detecting a collision of the response frames, wherein
the second determining unit determines the first and second response frame lengths and the first and second transmission timings so that the response frames returned from the first and second wireless terminals collide with each other given that the first and second wireless terminals are in the hidden terminal relation.

2. The wireless station according to claim 1, wherein
the first determining unit sets the first and second transmission rates to a same value,
the second determining unit
determines the first and second response frame lengths so that the response frames have an occupation time at least equal to the range of the initial backoff time, and
determines the first and second transmission timings so that the response request frame is first transmitted to one of the first and second wireless terminals having a greater one of the first and second communication delays and then to the other of the first and second wireless terminals having a smaller one of the communication delays with a delay equivalent to a difference between the first and second communication delays.

3. The wireless station according to claim 1, wherein
the first determining unit sets the first and second transmission rates to a same value, and
the second determining unit
determines the first and second response frame lengths so that the response frames have an occupation time at least twice the range of the initial backoff time, and
determines the first and second transmission timings so that the response request frame is first transmitted to one of the first and second wireless terminals having a greater one of the first and second communication delays and then to the other of the first and second wireless terminals having a smaller one of the communication delays with a delay equivalent to the difference between the first and second communication delays.

4. The wireless station according to claim 1, further comprising
an acquiring unit configured to communicate with the first and second wireless terminals and acquire information of transmission rates set in the first and second wireless terminals, wherein
the first determining unit determines the transmission rates indicated by the information as the first and second transmission rates.

5. The wireless station according to claim 1, wherein
the detecting unit detects that there has been occurred a collision of the response frames from the first and second wireless terminals when the response frames have not been received within a certain time period after transmission of the response request frame to each of the first and second wireless terminals.

6. The wireless station according to claim 1, wherein
the detecting unit detects that there has been occurred a collision of the response frames received from the first and second wireless terminals when a retransmission flag is set in each of the response frames returned from the first and second wireless terminals.

7. A wireless station that performs wireless communication with first and second wireless terminals based on a carrier sensing scheme, comprising:
a measuring unit configured to communicate with the first and second wireless terminals and measure first and second communication delays of the first and second wireless terminals;
a first determining unit configured to determine first and second transmission rates of the first and second wireless terminals;
a third determining unit configured to determine a common response frame length of response frames to be returned from the first and second wireless terminals for the first and second wireless terminals, based on the first and second transmission rates, the first and second communication delays, and a range of an initial backoff time for carrier sensing;
a transmitting unit configured to transmit a response request frame that requests returning of response frames having the common response frame length, to the first and second wireless terminals simultaneously by multicast or broadcast;
a receiving unit configured to receive the response frames returned from the first and second wireless terminals; and
a detecting unit configured to detect that the first and second wireless terminals are in hidden terminal relation upon detecting a collision of the response frames, wherein
the third determining unit determines the common response frame length so that the response frames returned from the first and second wireless terminals collide with each other given that the first and second wireless terminals are in the hidden terminal relation.

8. The wireless station according to claim 7, wherein
the first determining unit sets the first and second transmission rates to a same value, and
the third determining unit determines the common response frame length so that the response frames have an occupation time at least equal to a difference between:
a first sum which is a sum of a larger one of the first and second communication delays and a maximum value of the backoff time; and
a second sum which is a sum of a smaller one of the first and second communication delays and a minimum value of the backoff time.

9. The wireless station according to claim 7, wherein
the first determining unit sets the first and second transmission rates to a same value, and
determines the common response frame length so that the response frames have an occupation time at least equal to a sum of the length of the initial backoff time and a difference between:
a first sum which is a sum of a larger one of the first and second communication delays and a maximum value of the backoff time; and
a second sum which is a sum of a smaller one of the first and second communication delays and a minimum value of the backoff time.

10. The wireless station according to claim 7, further comprising
an acquiring unit configured to communicate with the first and second wireless terminals and acquire information of transmission rates set in the first and second wireless terminals, wherein
the first determining unit determines the transmission rates indicated by the information as the first and second transmission rates.

11. The wireless station according to claim 7, wherein
the detecting unit detects that there has been occurred a collision of the response frames from the first and second wireless terminals when the response frames have not been received within a certain time period after transmission of the response request frame to each of the first and second wireless terminals.

12. The wireless station according to claim 7, wherein
the detecting unit detects that there has been occurred a collision of the response frames received from the first and second wireless terminals when a retransmission flag is set in each of the response frames returned from the first and second wireless terminals.

13. A fault detecting method performed in a wireless station that performs wireless communication with first and second wireless terminals based on a carrier sensing scheme, comprising:
communicating with the first and second wireless terminals and measuring first and second communication delays of the first and second wireless terminals;
determining first and second transmission rates of the first and second wireless terminals;
determining first and second timings of transmitting a response request frame to each of the first and second wireless terminals and first and second response frame lengths of response frames to be returned from the first and second wireless terminals, based on the first and second transmission rates, the first and second communication delays, and a range of an initial backoff time for carrier sensing;
transmitting the response request frame that requests returning of response frames having the first and second response frame lengths at the first and second transmission rates, to the first and second wireless terminals at the first and second transmission timings;
receiving the response frames returned from the first and second wireless terminals; and
detecting that the first and second wireless terminals are in hidden terminal relation upon detecting a collision of the response frames, wherein
the determining timing and frame length includes determining the first and second response frame lengths and the first and second transmission timings so that the response frames returned from the first and second wireless terminals collide with each other given that the first and second wireless terminals are in the hidden terminal relation.

14. A computer readable medium storing a computer program for causing a computer that performs wireless communication with first and second wireless terminals based on a carrier sensing scheme, to execute instructions of the steps of:
communicating with the first and second wireless terminals and measuring first and second communication delays of the first and second wireless terminals;
determining first and second transmission rates of the first and second wireless terminals;
determining first and second timings of transmitting a response request frame to each of the first and second wireless terminals and first and second response frame lengths of response frames to be returned from the first and second wireless terminals, based on the first and second transmission rates, the first and second communication delays, and a range of an initial backoff time for carrier sensing;
transmitting the response request frame that requests returning of response frames having the first and second response frame lengths at the first and second transmission rates, to the first and second wireless terminals at the first and second transmission timings;
receiving the response frames returned from the first and second wireless terminals; and
detecting that the first and second wireless terminals are in hidden terminal relation upon detecting a collision of the response frames, wherein
the determining timing and frame length includes determining the first and second response frame lengths and the first and second transmission timings so that the response frames returned from the first and second wireless terminals collide with each other given that the first and second wireless terminals are in the hidden terminal relation.

15. A fault detecting method performed in a wireless station that performs wireless communication with first and second wireless terminals based on a carrier sensing scheme, comprising:
communicating with the first and second wireless terminals and measuring first and second communication delays of the first and second wireless terminals;
determining first and second transmission rates of the first and second wireless terminals;
determining a common response frame length of response frames to be returned from the first and second wireless terminals for the first and second wireless terminals, based on the first and second transmission rates, the first and second communication delays, and a range of an initial backoff time for carrier sensing;
transmitting a response request frame that requests returning of response frames having the common response frame length, to the first and second wireless terminals simultaneously by multicast or broadcast;
receiving the response frames returned from the first and second wireless terminals; and
detecting that the first and second wireless terminals are in hidden terminal relation upon detecting a collision of the response frames, wherein
the determining a common response frame length includes determining the common response frame length so that the response frames returned from the first and second wireless terminals collide with each other given that the first and second wireless terminals are in the hidden terminal relation.

16. A computer readable medium storing a computer program for causing a computer that performs wireless communication with first and second wireless terminals based on a carrier sensing scheme, to execute instructions of the steps of:
communicating with the first and second wireless terminals and measuring first and second communication delays of the first and second wireless terminals;
determining first and second transmission rates of the first and second wireless terminals;
determining a common response frame length of response frames to be returned from the first and second wireless terminals for the first and second wireless terminals, based on the first and second transmission rates, the first and second communication delays, and a range of an initial backoff time for carrier sensing;
transmitting a response request frame that requests returning of response frames having the common response frame length, to the first and second wireless terminals simultaneously by multicast or broadcast;
receiving the response frames returned from the first and second wireless terminals; and
detecting that the first and second wireless terminals are in hidden terminal relation upon detecting a collision of the response frames, wherein
the determining a common response frame length includes determining the common response frame length so that the response frames returned from the first and second wireless terminals collide with each other given that the first and second wireless terminals are in the hidden terminal relation.
